(19) United States
(12) Patent Application Publication
(10) Pub. No.: US 2005/0071885 A1
(43) Pub. Date: Mar. 31, 2005

(54) Contents reproduction system, reproduction device and contents reproduction method

(75) Inventor: Hiroshi Matoba, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/952,511

(22) Filed: Sep. 29, 2004

(30) Foreign Application Priority Data
Sep. 30, 2003 (JP) 2003-340499

(51) Int. Cl. H04N 5/445; G06F 3/00; G11B 20/10; G11B 19/02; G11B 15/52; G11B 5/09; H04N 5/44

(52) U.S. Cl. 725/131; 725/38; 348/734; 348/725

(57) ABSTRACT

A recorder which reproduces contents and a remote controller which remotely operates the recorder are provided. The remote controller, which has a data base which stores context information indicating up to which position in the contents its reproduction has been made, when the recorder reproduces the contents by remote operation, transmits information for rewriting the context information in the data base based on the position in the contents obtained at the time when the reproduction ends to the remote controller by mail.

### BACKGROUND OF THE INVENTION

1. Field of the Invention

The present invention relates to a system and a method which reproduce contents (broadcast programs such as a TV program and a radio program and video distributed through the Internet) by, for example, an HDD (Hard Disk Drive) recorder, a DVD (Digital Versatile Disk) recorder, a VCR (Video Cassette Recorder) and a PVR (Personal Video Recorder).

2. Description of the Related Art

In these days, recorders having a large capacity such as an HDD recorder have been widely used to enable users to record numbers of programs with ease. It is expected from now on that capacities of recorders will be further increased to allow users to record programs without giving much attention to the number of programs and the like to be recorded. Such condition arouses the need of assuming that users will view and listen to recorded programs in situations different from those before. When an increase in capacities will be enhanced, possible are cases, for example, where a program you recorded is also recorded by your friend and where the same program you recorded at home is also recorded by a shared recorder disposed in office or elsewhere. In these cases, you may view and listen to a remaining part of a program you have viewed and listened to halfway by your own recorder at home by a recorder disposed at your friend's house or at office. In such a manner of viewing and listening, continuity of contents reproduction between different recorders should be maintained.

Maintaining state continuity between a plurality of home electronic appliances (recorders) is realized, for example, by the remote control system recited in Japanese Patent Laying-Open (Kokai) No. 2000-92344 (Literature 1). In this remote control system, with state information of a home electronic appliance as a control apparatus to be controlled stored in a remote control device (hereinafter referred to as a remote controller), by remotely controlling other home electronic appliance based on the stored state information, continuity of operation in the past and operation at present in the two home electronic appliances is maintained.

One mode of sharing a terminal is such a viewing system as recited in Japanese Patent Laying-Open (Kokai) No. 2002-140256 (Literature 2). The viewing system is composed of an information accumulation device provided on a network for accumulating multimedia data (numerical values, characters, still images, moving pictures, etc.), a personal terminal and a shared terminal connected to the information accumulation device through the network and a control device (remote controller) shared by the personal terminal and the shared terminal. By using the remote controller, users can obtain desired multimedia data from the information accumulation device and view and listen to the same on the personal terminal and the shared terminal.

The above-described conventional systems, however, have the following problems.

In a case of viewing the continuation of a program viewed and listened to halfway by a certain recorder by other recorder, for reproducing the continuation, it is ordinarily necessary to conduct operation of forwarding the reproduction to a part interrupted at the preceding viewing and listening by using the rapid forwarding function, which is laborious operation.

While the system recited in Literature 1 enables continuity of operation state to be maintained between different recorders, such rapid forwarding operation as described above is required to reproduce the contents starting at a part interrupted in the preceding viewing and listening because the system is not designed to maintain continuity of contents reproduction.

The system recited in Literature 2 also only enables desired multimedia data to be viewed and listened to on a different terminal by using one remote controller and in this case as well, it is necessary to conduct such rapid forwarding operation as above described in order to reproduce contents starting at a part interrupted in the preceding viewing and listening.

### SUMMARY OF THE INVENTION

The object of the present invention is to provide a contents reproduction system and a contents reproduction method which solve the above-described problems and enable continuity of contents reproduction to be maintained.

According to the first aspect of the invention, a contents reproduction system comprises a reproduction device which reproduces contents, a remote control device which remotely operates the reproduction device, and a context information storage device which stores context information related to reproduction of the contents, wherein the reproduction device, when reproducing the contents by remote operation, rewrites the context information in the context information storage device based on a state of the contents in question as of after reproduction.

In the preferred construction, the reproduction device includes first communication unit, and a first control unit which transmits updated contents based on a state of the contents as of after reproduction from the first communication unit to the remote control device, and the remote control device includes second communication unit which receives the updated contents transmitted from the reproduction device, and a second control unit which updates the context information in the context information storage device based on the updated contents received by the second communication uni.

In another preferred construction, the reproduction device includes first communication unit, and a first control unit which transmits updated contents based on a state of the contents as of after reproduction from the first communication unit to the remote control device, and the remote control device includes second communication unit which receives the updated contents transmitted from the reproduction device, and a second control unit which updates the context information in the context information storage device based on the updated contents received by the second communication unit, the first communication unit transmits a mail containing the updated contents and the second communication unit receives the mail.

In another preferred construction, the reproduction device includes first communication unit, and a first control unit which transmits updated contents based on a state of the contents as of after reproduction from the first communication unit to the remote control device, and the remote control device includes second communication unit which receives the updated contents transmitted from the reproduction device, and a second control unit which updates the context information in the context information storage device based on the updated contents received by the second communication unit, the first and second communication unit are a radio communication unit.

In another preferred construction, the contents reproduction system further comprises a recording medium attachable to each of the reproduction device and the remote control device, wherein the reproduction device records updated contents based on a state of the contents as of after reproduction on the recording medium, and when the recording medium in which the updated contents are recorded is attached, the remote control device reads the updated contents from the attached recording medium to update the context information in the context information storage device based on the read updated contents.

In another preferred construction, the context information storage device and the reproduction device are connected to be communicable with each other through a network and the reproduction device directly updates the context information in the context information storage device based on a state of the contents as of after reproduction.

In another preferred construction, the contents reproduction system further comprises other remote control device which remotely operates the reproduction device, wherein with the context information being stored for each the remote control device, the context information storage device, when the reproduction device reproduces the contents by remote operation of any of the remote control devices, rewrites context information of the relevant remote control device in the context information storage device based on a state of the contents in question as of after reproduction.

In another preferred construction, the context information storage device includes a first data base where a contents ID which specifies the contents and the context information are stored to be correlated with each other, the first data base being provided in the remote control device.

In another preferred construction, the context information storage device includes a first data base where a contents ID which specifies the contents and the context information are stored to be correlated with each other, the first data base being provided in the remote control device, the context information storage device further includes a second data base where a device ID which specifies the remote control device, the contents ID and context information are stored to be correlated with each other, and a third data base where a mail address set in advance to the remote control device and context information latest updating time and date equivalent to time and date when the context information is rewritten last are stored to be correlated with the device ID, the second and third data bases being provided in the reproduction device, the reproduction device rewrites the context information in the second data base based on a state of the contents as of after reproduction, as well as updating the context information latest updating time and date in the third data base to transmit the rewritten contents of the context information in question to the mail address in the third data base, and the remote control device updates the context information in the first data base based on contents of a mail received from the reproduction device.

In another preferred construction, the context information storage device includes a first data base where a contents ID which specifies the contents and the context information are stored to be correlated with each other, the first data base being provided in the remote control device, the context information storage device further includes a second data base where a device ID which specifies the remote control device, the contents ID and context information are stored to be correlated with each other, and a third data base where a mail address set in advance to the remote control device and context information latest updating time and date equivalent to time and date when the context information is rewritten last are stored to be correlated with the device ID, the second and third data bases being provided in the reproduction device, the reproduction device rewrites the context information in the second data base based on a state of the contents as of after reproduction, as well as updating the context information latest updating time and date in the third data base to transmit the rewritten contents of the context information in question to the mail address in the third data base,
the remote control device updates the context information in the first data base based on contents of a mail received from the reproduction device, the reproduction device further includes a display unit, the remote control device transmits time and date when the context information in the first data base is updated last to the reproduction device, and the reproduction device checks whether the time and date received from the remote control device coincides with the context information latest updating time and date in the third data base and when the times and dates fail to coincide with each other, causes the display unit to make a display urging update of the context information in the second data base.

In another preferred construction, the context information storage device includes a first data base where a contents ID which specifies the contents and the context information are stored to be correlated with each other, the first data base being provided in the remote control device, the context information storage device further includes a second data base where a device ID which specifies the remote control device, the contents ID and context information are stored to be correlated with each other, and a third data base where a mail address set in advance to the remote control device and context information latest updating time and date equivalent to time and date when the context information is rewritten last are stored to be correlated with the device ID, the second and third data bases being provided in the reproduction device, the reproduction device rewrites the context information in the second data base based on a state of the contents as of after reproduction, as well as updating the context information latest updating time and date in the third data base to transmit the rewritten contents of the context information in question to the mail address in the third data base, the remote control device updates the context information in the first data base based on contents of a mail received from the reproduction device, the reproduction device further includes a display unit,
the remote control device transmits time and date when the context information in the first data base is updated last to the reproduction device, the reproduction device checks whether the time and date received form the remote control device coincides with the context information latest updating time and date in the third data base and when the times and dates fail to coincide with each other, causes the display unit to make a display urging update of the context information in the second data base, the remote control device includes an updating button and when a user presses the updating button according to the display urging update, transmits the context information in the first data base to the reproduction device, and the reproduction device updates the context information in the second data base based on the context information received from the remote control device.

In another preferred construction, the context information storage device includes a first data base where a contents ID which specifies the contents and the context information are stored to be correlated with each other, the first data base being provided in the remote control device, the context information storage device further includes a second data base where a device ID which specifies the remote control device, the contents ID and context information are stored to be correlated with each other, and a third data base where a mail address set in advance to the remote control device and context information latest updating time and date equivalent to time and date when the context information is rewritten last are stored to be correlated with the device ID, the second and third data bases being provided in the reproduction device, the reproduction device rewrites the context information in the second data base based on a state of the contents as of after reproduction, as well as updating the context information latest updating time and date in the third data base to transmit the rewritten contents of the context information in question to the mail address in the third data base, the remote control device updates the context information in the first data base based on contents of a mail received from the reproduction device, and the reproduction device is capable of reproducing at least one other contents than the contents, the first and second data bases each storing the contents ID and the context information with respect to each the contents.

In another preferred construction, the context information storage device includes a first data base where a contents ID which specifies the contents and the context information are stored to be correlated with each other, the first data base being provided in the remote control device, the context information storage device further includes a second data base where a device ID which specifies the remote control device, the contents ID and context information are stored to be correlated with each other, and a third data base where a mail address set in advance to the remote control device and context information latest updating time and date equivalent to time and date when the context information is rewritten last are stored to be correlated with the device ID, the second and third data bases being provided in the reproduction device, the reproduction device rewrites the context information in the second data base based on a state of the contents as of after reproduction, as well as updating the context information latest updating time and date in the third data base to transmit the rewritten contents of the context information in question to the mail address in the third data base, and the remote control device updates the context information in the first data base based on contents of a mail received from the reproduction device, and which further comprises other remote control device which remotely operates the reproduction device, wherein the second data base stores the contents ID and the context information with respect to each the remote control device, and the third data base stores the mail address and the context information latest updating time and date with respect to each the remote control device.

In another preferred construction, the context information storage device includes a first data base where a contents ID which specifies the contents and the context information are stored to be correlated with each other, the first data base being provided in the remote control device, the context information storage device further includes a second data base where a device ID which specifies the remote control device, the contents ID and context information are stored to be correlated with each other, and a third data base where a mail address set in advance to the remote control device and context information latest updating time and date equivalent to time and date when the context information is rewritten last are stored to be correlated with the device ID, the second and third data bases being provided in the reproduction device, the reproduction device rewrites the context information in the second data base based on a state of the contents as of after reproduction, as well as updating the context information latest updating time and date in the third data base to transmit the rewritten contents of the context information in question to the mail address in the third data base, the remote control device updates the context information in the first data base based on contents of a mail received from the reproduction device, and the reproduction device is capable of reproducing at least one other contents than the contents, the first and second data bases each storing the contents ID and the context information with respect to each the contents, and which further comprises other remote control device which remotely operates the reproduction device, wherein the second data base stores the contents ID and the context information with respect to each the remote control device, and the third data base stores the mail address and the context information latest updating time and date with respect to each the remote control device.

In another preferred construction, the contents reproduction system further comprises a recording medium attachable to each of the reproduction device and the remote control device, wherein the reproduction device further includes recording unit which records the contents on the recording medium, and the remote control device further includes reproduction unit which reproduces contents recorded in the recording medium and when the reproduction unit reproduces contents recorded in the recording medium, rewrites the context information in the context information storage device based on a state of the contents in question as of after reproduction.

In another preferred construction, the contents reproduction system further comprises a recording medium attachable to each of the reproduction device and the remote control device, wherein the reproduction device further includes recording unit which records the contents on the recording medium, the remote control device further includes reproduction unit which reproduces contents recorded in the recording medium and when the reproduction unit reproduces contents recorded in the recording medium, rewrites the context information in the context information storage device based on a state of the contents in question as of after reproduction, the context information storage device includes a data base where a contents ID which specifies the contents and the context information are stored to be correlated with each other, the data base being provided in the remote control device, and wherein the remote control device rewrites the context information in the data base based on a state of contents reproduced by the reproduction unit.

In another preferred construction, the contents reproduction system further comprises a recording medium attachable to each of the reproduction device and the remote control device, wherein the reproduction device further includes recording unit which records the contents on the recording medium, the remote control device further includes reproduction unit which reproduces contents recorded in the recording medium and when the reproduction unit reproduces contents recorded in the recording medium, rewrites the context information in the context information storage device based on a state of the contents in question as of after reproduction, the context information storage device includes a data base where a contents ID which specifies the contents and the context information are stored to be correlated with each other, the data base being provided in the remote control device, and wherein the remote control device here rewrites the context information in the data base based on a state of contents reproduced by the reproduction unit, the reproduction device is capable of reproducing at least one other contents than the contents, the data base storing the contents ID and the context information with respect to each the contents, and the recording unit recording contents selected from among the reproducible contents on the recording medium, and the remote control device rewrites context information of relevant contents in the data base based on a state of contents reproduced by the reproduction unit.

According to another aspect of the invention, a contents reproduction method executed in a system having a reproduction device which reproduces contents, a remote control device which remotely operates the reproduction device, and a context information storage device which stores context information related to reproduction of the contents, comprising the step of the reproduction device, after reproducing the contents by remote operation, rewriting the context information in the context information storage device based on a state of the contents in question as of after reproduction.

According to another aspect of the invention, a reproduction system which reproduces contents, which is connected to a context information storage device which stores context information related to reproduction of the contents, and when reproducing the contents by remote operation of a remote control device, rewrites the context information in the context information storage device based on a state of the contents in question as of after reproduction.

According to the present invention, when contents are reproduced by a reproduction device through remote operation by using a remote control device, context information related to reproduction of the content, for example, information indicating up to which position of the content its reproduction has been made, is stored in a context information storage device. As a result, by using the context information stored in the context information storage device at the time of subsequent reproduction by remote operation by using the remote control device, even other reproduction device is allowed to reproduce the continuation of the content.

According to the present invention, transmission of updated contents from the reproduction device to the remote control device may be conducted by a mail or radio communication. When using a mail, the system can be set up by using an existing network communication system without introducing a new system of a large scale. When using radio, instantaneous transmission of updated contents from the reproduction device to the remote control device is possible to enable real-time update of context information.

In addition, such arrangement as described above enables a system capable of conducting real-time update of context information to be realized by a simple and low-cost structure.

Moreover, such arrangement eliminates the need of having context information in the reproduction device.

Furthermore, in a case, for example, where one reproduction device is used by a plurality of remote control devices, such arrangement enables each remote control device to reproduce a continuation of a content (to maintain continuity of contents reproduction).

This arrangement further enables continuity of contents reproduction to be maintained between the remote control device and a recorder.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a schematic diagram for use in explaining a contents reproduction system according to a first embodiment of the present invention;

FIG. 2 is a block diagram showing a main part of a remote controller illustrated in FIG. 1;

FIG. 3 is a schematic diagram showing an example of arrangement of buttons of the remote controller illustrated in FIG. 1;

FIG. 4 is a diagram showing one example of a table stored in a context information DB illustrated in FIG. 2;

FIG. 5 is a flow chart for use in explaining operation involved in button operation at the remote controller illustrated in FIG. 1;

FIG. 6 is a flow chart for use in explaining operation involved in mail reception operation at the remote controller illustrated in FIG. 1;

FIG. 7 is a block diagram showing a main part of a recorder illustrated in FIG. 2;

FIG. 8 is a diagram showing one example of a table stored in a context information DB illustrated in FIG. 7;

FIG. 9 is a diagram showing one example of a table stored in a user DB illustrated in FIG. 7;

FIG. 10 is a flow chart for use in explaining operation involved in remote controller operation at the recorder illustrated in FIG. 1;

FIG. 11 is a flow chart showing a procedure of determining on processing end illustrated in FIG. 10;

FIG. 12 is a schematic diagram for use in explaining a contents reproduction system according to a second embodiment of the present invention; and

FIG. 13 is a schematic diagram for use in explaining a contents reproduction system according to a third embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

(First Embodiment)

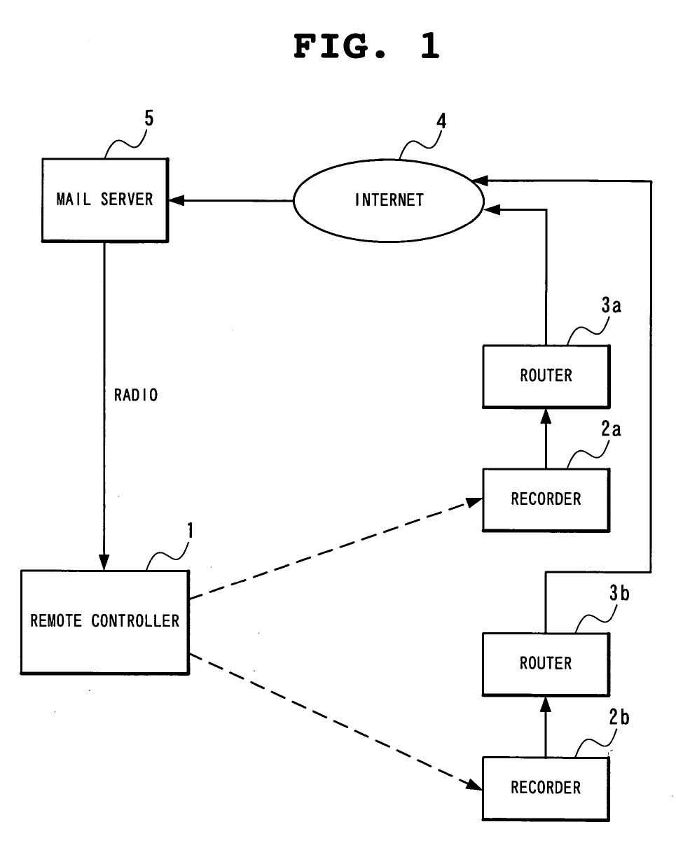

FIG. 1 shows a schematic diagram for use in explaining a contents reproduction system according to the first embodiment of the present invention. The contents reproduction system includes a remote controller 1, and recorders 2a and 2b which are disposed at different places or houses and which can be remotely controlled by the remote controller 1. The recorder 2a and the recorder 2b are connected to an internet 4 through routers 3a and 3b, respectively. Each of the recorders 2a and 2b has a function of accumulating (recording) externally supplied contents other than the internet 4 connection function and the electronic mail transmission function.

Possible contents to be accumulated in the recorders 2a and 2b include broadcast programs such as a television program and a radio program and multimedia data distributed from a distribution server not shown through the internet 4. In a mail transmitted from the recorders 2a and 2b, information for maintaining continuity of contents reproduction is stored.

On the internet 4, a mail server 5 is disposed. The mail server 5 has a function of transmitting a mail from the recorders 2a and 2b to the remote controller 1 through the internet 4 or existing wide area radio communication. The remote controller 1 has a function, other than the remote control function known for television and video apparatuses, of receiving a mail from the recorders 2a and 2b through the mail server 5 to obtain information for maintaining continuity of contents reproduction. Such a remote controller 1 can be realized, for example, by mounting a remote control function and a function of obtaining information for maintaining continuity of contents reproduction on a portable telephone terminal. The remote controller 1 can be formed also by a portable communication terminal such as a PDA (Personal Digital Assistance).

With the contents reproduction system according to the present embodiment, transmission of information from the remote controller 1 to the recorder 2a (or recorder 2b) is conducted by infrared communication and transmission of information from the recorder 2a (or recorder 2b) to the remote controller 1 is conducted by mail transmission through the internet 4. This enables inter-communication between the remote controller 1 and the recorders 2a and 2b. In addition, the system is designed to maintain continuity of contents reproduction between the recorders 2a and 2b by the transmission and reception of context information composed of information related to contents and information for specifying up to which position of the contents its reproduction has been made between the remote controller 1 and the recorders 2a and 2b. In a case, for example, of viewing and listening to the continuation of contents viewed and listened to halfway by the recorder 2a by means of the recorder 2b, obtain context information related to reproduced contents from the recorder 2a by a mail by means of the remote controller 1 and based on the obtained context information, make the recorder 2b to reproduce the continuation of the contents. Thus, continuity of the contents reproduction between the recorders 2a and 2b is maintained.

In the following, description will be made of specific structure and operation of the remote controller 1 and the recorders 2a and 2b.

(1) Remote Controller

(Structure)

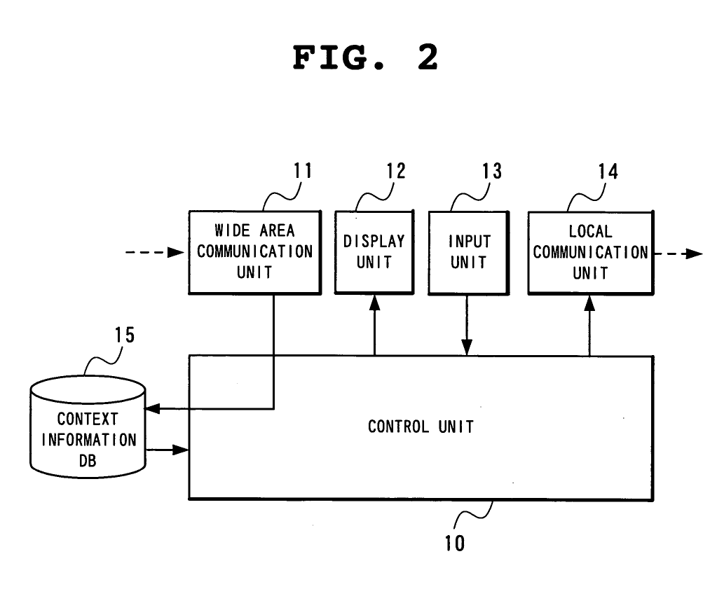

FIG. 2 shows a main part of the remote controller 1. With reference to FIG. 2, the remote controller 1 includes a wide area communication unit 11 as a radio communication means for receiving a mail from the mail server 5, a display unit 12 formed of a liquid crystal display or the like, an input unit 13 in which a plurality of buttons for remote controller operation are disposed, a local communication unit 14 as a communication means for remotely operating the recorder 2a (or recorder 2b), a context information DB (Data Base) 15 in which information for maintaining continuity of contents reproduction is stored and a control unit 10 which receives input from the input unit 13 to control operation of each unit.

The wide area communication unit 11 is a radio communication means which uses wide area radio communication media known, for example, for portable phones. The wide area communication unit 11 is capable of receiving a mail from the mail server 5 within an area in which wide area radio communication media is available. The local communication unit 14 is an infrared communication means used in existing remote controllers. Communication by the local communication unit 14 is one-way communication from the remote controller 1 to the recorder 2a.

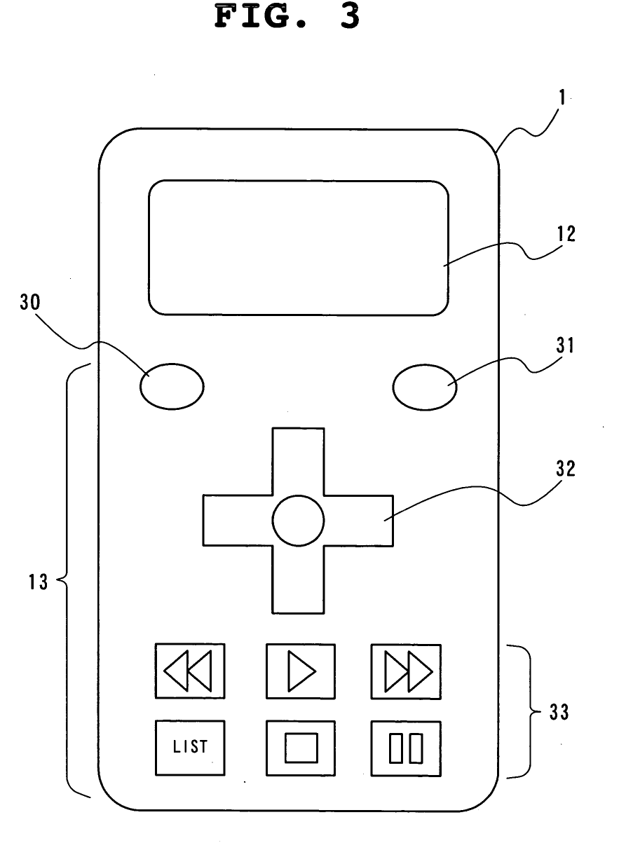

Prepared in the input unit 13 are a plurality of A buttons for remotely controlling reproduction of contents at the recorder side and a B button for updating context information on the recorder side. FIG. 3 schematically shows an arrangement example of the respective buttons of the input unit 13. In this example, provided are an updating button 30 for updating context information, a power button 31 for on/off controlling power on the recorder side, a cross key 32 for selecting a necessary item from the respective items in a menu displayed on a display screen of an external device such as a TV or selecting desired contents from a displayed contents list through the recorder and control buttons 33 which control the operation for reproducing contents on the recorder side.

The control buttons 33 include a reproduction button, a stop button, a forward button, a rewind button and a list button. The power button 31, the cross key 32 and the control buttons 33 are the A buttons and the updating button is the B button. When a user wants to reproduce contents by the recorder, he/she operates the A buttons and when updating context information on the recorder side, he/she operates the B button.

The control unit 10 causes transmission of information necessary for contents reproduction from the local communication unit 14 to the recorder according to A button operation and causes transmission of information necessary for updating context information from the local communication unit 14 to the recorder according to B button operation. The control unit 10 also causes the display unit 12 to display a message necessary for remote controller operation. Furthermore, when a mail from the recorder which has reproduced the contents by remote controller operation is received by the wide area communication unit 11, the control unit 10 stores contents information contained in the received mail and its context in the context information DB 15, as well as storing time and date of reception of the mail in a storage unit not shown. When the contents information is already stored in the context information DB 15, the control unit 10 updates relevant context in the context information DB 15 assuming that the context contained in the mail is the latest.

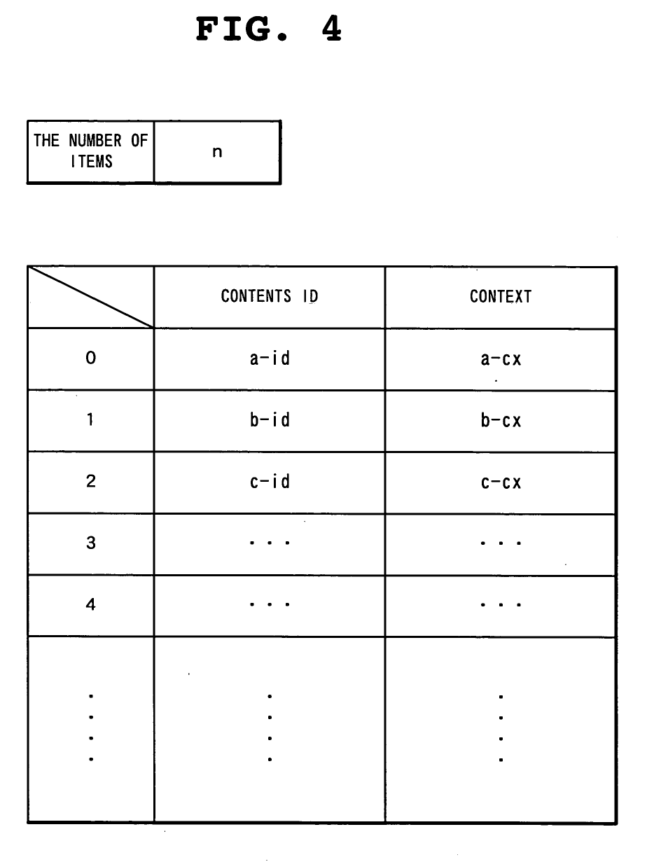

FIG. 4 shows one example of a table stored in the context information DB 15. In this example, stored in the context information DB 15 is a table composed of items of a contents ID and its context as contents information. Contents ID is information for specifying a reproduced content, which includes information such as a broadcasting station name, a broadcast program name and broadcasting time (indicating from what time to what time a program has been broadcast) as absolute time information. Context is relative time information indicating up to which part of the content its reproduction has been made (up to which position in the content its reproduction is made) and is given as the number of frames from the top of the contents or a counter value, for example. Context information is composed of these contents ID and context. In addition, the context information DB 15 is further provided with an item indicative of the number of information stored.

(Operation)

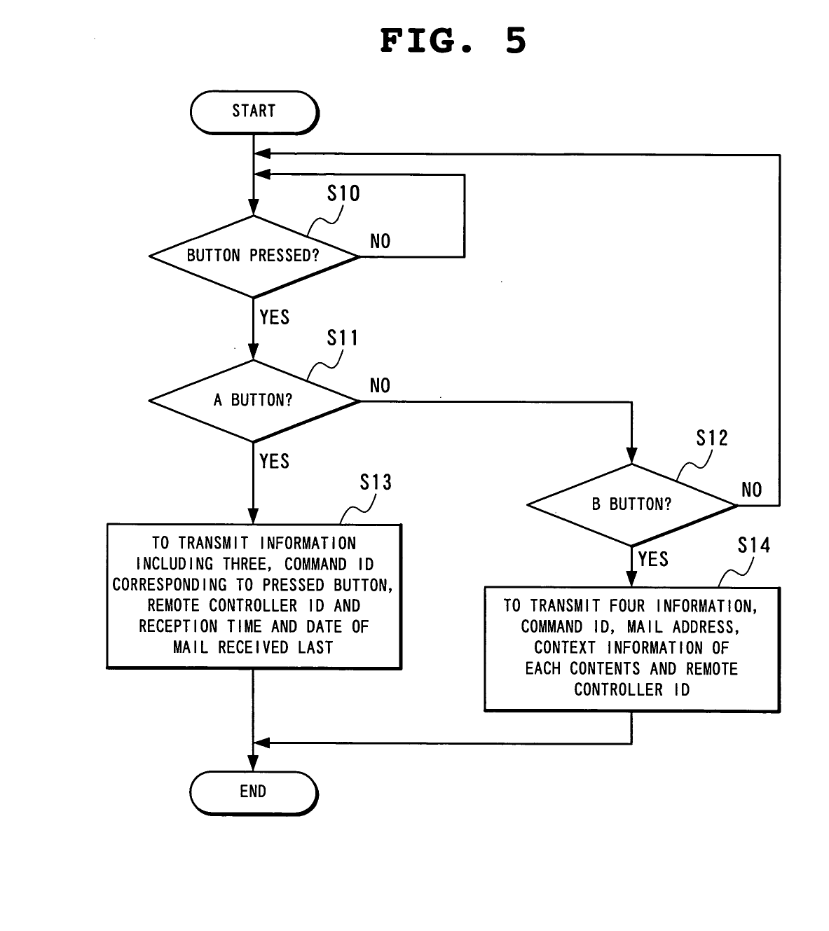

FIG. 5 is a flow chart for use in explaining control operation by the control unit 10 involved in button operation at the remote controller 1. First, determination is made whether a button is pressed (Step S10). When the determination has “No”, return to Step S10 and when it has “Yes”, determination is subsequently made whether the pressed button is the A button or not (Step S11). When the determination has “No”, determination is subsequently made whether the pressed button is the B button (Step S12). When this determination has “No”, return to Step S10.

When the determination at Step S11 has “Yes”, transmit, from the local communication unit 14 to the recorder, information containing the following three (Step S13):
*command ID corresponding to the pressed button,
*remote controller ID, and
*time and date of reception of a mail received lastly from the recorder.
   Here, “remote controller ID” is a number for specifying the remote controller 1 and is assigned to the remote controller 1 in advance. “Mail received lastly from the recorder” represents a mail received from the recorder which has lastly conducted contents reproduction by remote controller operation and its reception time and date represents time and date when the mail is received by the remote controller 1. The reception time and date is stored in a storage unit not shown in the remote controller 1.

When the determination at Step S12 has “Yes”, transmit, from the local communication unit 14 to the recorder, the information containing the following four (Step S14):
*command ID corresponding to the pressed button,
*mail address,
*remote controller ID, and
*context information of each contents.
   Here, “mail address” is a mail address set in advance at the remote controller 1 for receiving a mail from the recorder. “Context information of each contents” represents context information of each contents stored in the context information DB 15 (see FIG. 4). In practice, a contents ID is transmitted together with the context information.

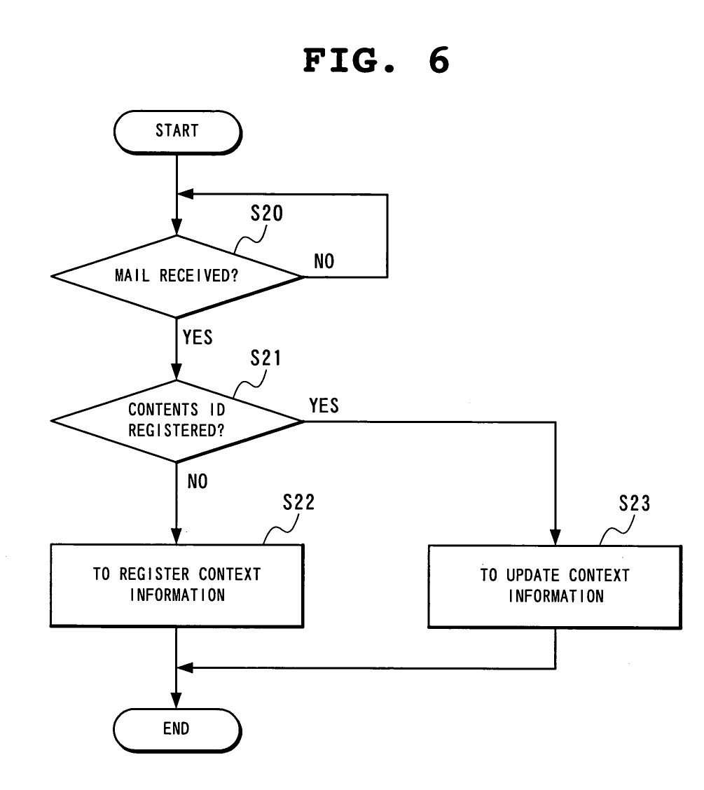

FIG. 6 is a flow chart for use in explaining control operation by the control unit 1 involved in mail reception operation at the remote controller 1. First, determination is made whether a mail from the recorder is received by the wide area communication unit 11 or not (Step S20). When the determination has “No”, return to Step S20 and when the same has “Yes”, determination is subsequently made whether contents ID contained in the received mail is registered in the context information DB 15 (Step S21). When the determination has “No”, register the contents ID and the context information stored in the mail at the context information DB 15 and when the same has “Yes”, replace context information of the relevant contents ID in the context information DB 15 with the context information contained in the mail (updating). Thus, latest context information will be stored in the context information DB 15.

(2) Recorder

(Structure)

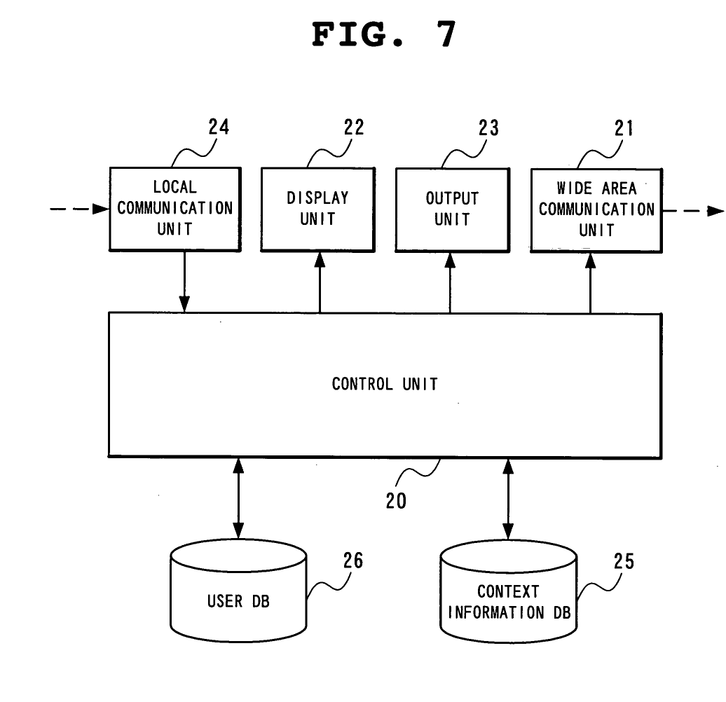

Since the recorders 2a and 2b have the same structure, description will be here made of a specific structure of the recorder 2a as an example. FIG. 7 shows a main part of the recorder 2a. With reference to FIG. 7, the recorder 2a includes a wide area communication unit 21 as a radio communication means for transmitting a mail to the mail server 5, a display unit 22 formed of a liquid crystal display or the like, an output unit 23 for outputting contents accumulated in a storage unit not shown to an external device (TV etc.), a local communication unit 24 for conducting infrared communication with the remote controller 1, a context information DB 25 and a user DB 26 in which information for maintaining continuity of contents reproduction is stored and a control unit 20 for controlling operation of each unit according to input (command signal) by remote operation by using the remote controller 1.

The local communication unit 24, which is such an infrared communication means as provided in an existing recorder, forms a one-way (direction from the remote controller 1 to the recorder 2) communication means together with the local communication unit 13 on the remote controller 1 side. The local communication unit 24 receives information involved in A button operation (a command ID corresponding to a pressed button, a remote controller ID and reception time and date of a mail received lastly from the recorder) and information involved in B button operation (a mail address, a remote controller ID and context information of each contents) from the remote controller 1.

The wide area communication unit 21 is a wide area communication means through an existing internet. Together with the wide area communication unit 11 on the remote controller 1 side, the wide area communication unit 21 forms a one-way (direction from the recorder 2a to the remote controller 1) communication means by mails.

The control unit 20 determines whether a remote controller ID is registered in the user DB 26 or determines whether context information on the remote controller 1 side and the recorder 2a side coincide with each other based on information involved in A button operation which is received by the local communication unit 24. The control unit 20 also registers necessary information to the context information DB 25 and the user DB 26 based on information involved in B button operation which is received by the local communication unit 24. Furthermore, in a case where a remote controller ID is registered and updating conditions of the context information on the remote controller 1 side and the recorder side coincide with each other, the control unit 20 conducts operation control according to a command ID of a pressed A button and otherwise causes the display unit 22 to display a message urging a press of the B button. Under the operation control by the control unit 20, when the power button 31 shown in FIG. 3 is pressed, for example, the state of the recorder 2a shifts from the off state to the on state, and in the power-on state, when the control button 33 is pressed, a series of operation for contents reproduction (contents list display, contents selection, reproduction, stop, forwarding and rewinding, etc.) is conducted. In the power-on state, when the power button 31 is pressed for a long period of time, the state of the recorder 2a shifts from the on state to the off state. At the time of shifting to the off state, the control unit 20 updates context information of reproduced contents which is stored in the context information DB 25, as well as transmitting a mail containing the updated context information (contents information and context) from the wide area communication unit 21 to the remote controller 1.

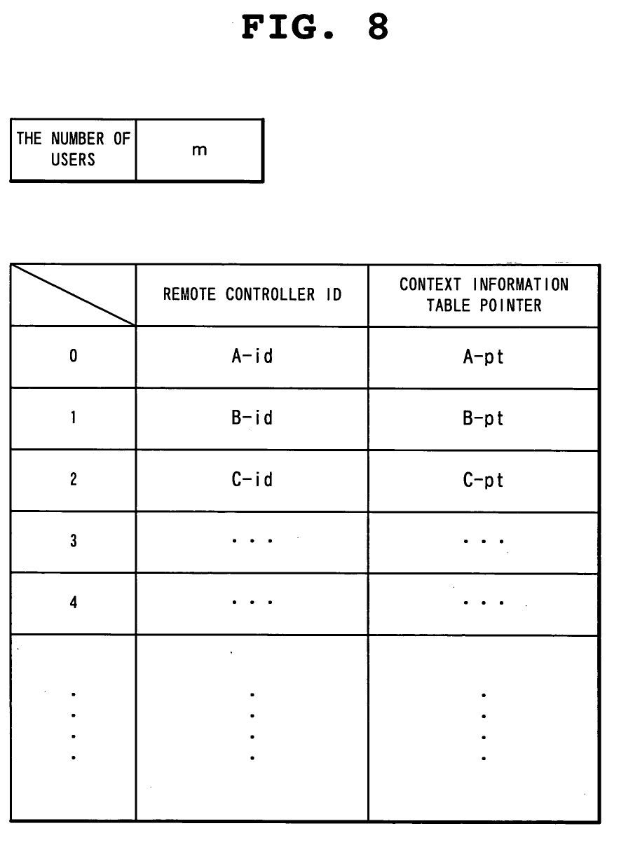

FIG. 8 shows one example of a table stored in the context information DB 25. Stored in the context information DB 25 is, other than a first table composed of items of a remote controller ID and a context information table pointer, such a second table not shown which is composed of a contents ID and context information as shown in FIG. 4 (in this case, mail reception time and date is not included). Remote controller ID is an ID number of a remote controller which conducts remote controller operation of the recorder 2a and is assigned to a remote controller in advance. For each remote controller ID, the second table is prepared each of which is correlated to a context information table pointer. In addition, an item of the number of users (corresponding to the number of remote controllers) is provided in the context information DB 25. In the updating of context information at the time of above-described shift to the power-off state, the control unit 20 refers to the first table to search for a second table based on a remote controller ID and updates context information of the relevant second table.

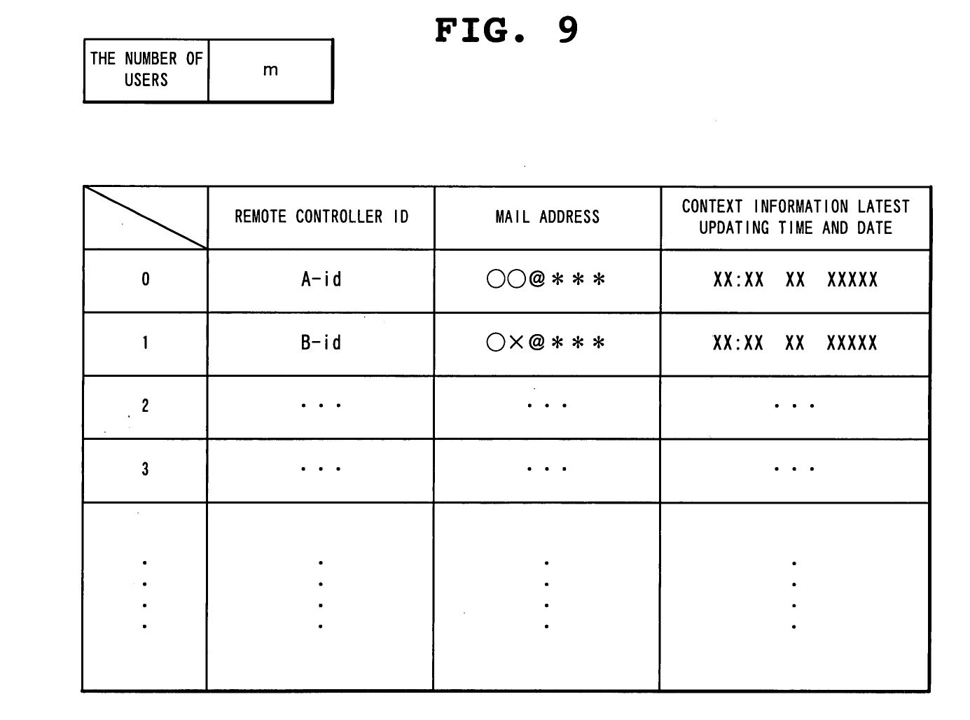

FIG. 9 shows one example of a table stored in the user DB 26. Stored in the user DB 26 is a table composed of three items of a remote controller ID, a mail address and a context information latest updating time and date. The remote controller ID is the same as the remote controller ID of the context information DB 25 shown in FIG. 8. Mail address, which is assigned to the remote controller in advance, is used at the time of mail transmission to the remote controller. Context information latest updating time and date is the above-described updating time and date of context information of the second table by the control unit 20 (corresponding to the updating time and date of the context information DB 15 on the remote controller 1 side). The control unit 20 determines whether context information on the remote controller 1 side and the recorder 2a side coincide with each other according to whether the context information latest updating time and date coincides with mail reception time and date sent from the remote controller.

(Operation)

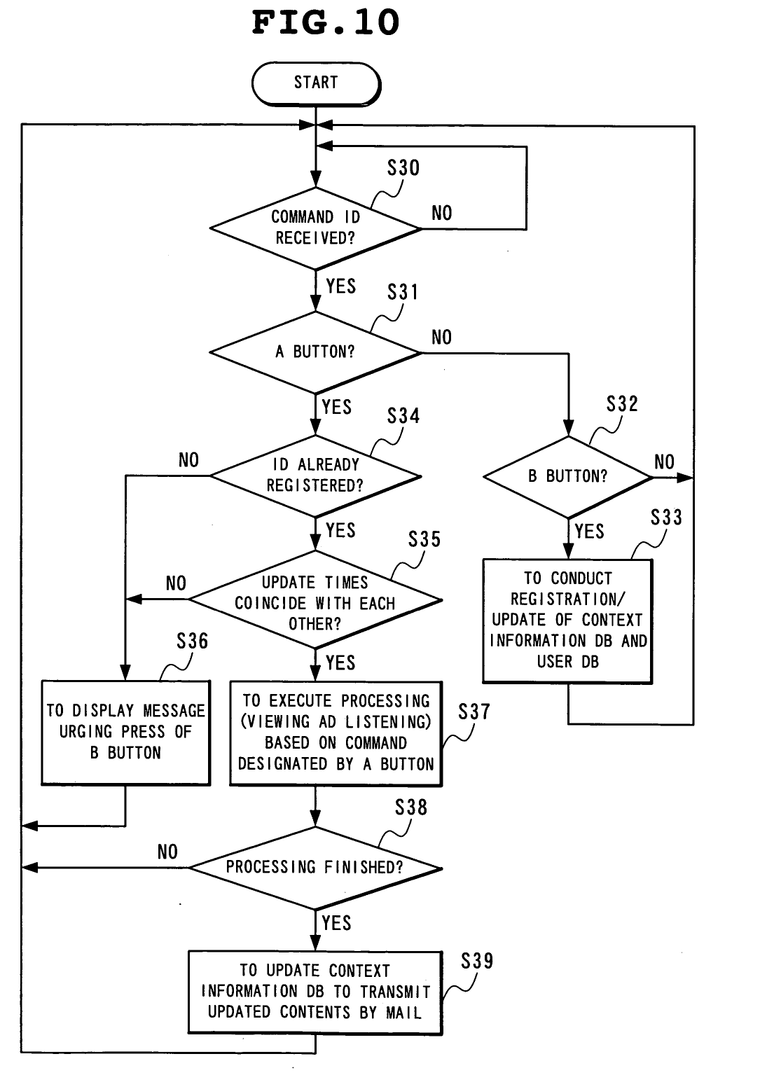

FIG. 10 is a flow chart for use in explaining control operation by the control unit 20 involved in remote controller operation. Determination is made whether a command ID involved in button operation from the remote controller 1 is received by the local communication unit 24 (Step S30). When the determination has “No”, return to Step S30 and when the determination has “Yes”, determination is subsequently made whether the command ID is made by pressing the A button (Step S31). When the determination has “No”, determination is subsequently made whether the command ID is made by pressing the B button (Step S32). When the determination has “No”, return to Step S30 and when the same has “Yes”, conduct registration/update of the context information DB 25 and the user DB 26 based on a mail address, a remote controller ID and context information of each contents received together with the command ID (Step S33). In this registration/updating processing, when the remote controller ID received from the remote controller 1 is already registered in the context information DB 25 and the user DB 26, search for the second table according to the first context information table pointer of the context information DB 25 and replace context information in the searched second table with the context information of each contents received from the remote controller 1 (updating). When the remote controller ID received from the remote controller 1 is yet to be registered in the context information DB 25 and the user DB 26, register the remote controller ID received from the remote controller 1 at the first table of the context information DB 25, as well as newly generating a second table to store context information of each contents received from the remote controller 1 in the table, and storing (registering) a table pointer to the second table in a column in which a previous remote controller ID of the first table is registered. After the registration/updating, again return to Step S30.

When the determination at Step S31 has “Yes”, determination is subsequently made whether the remote controller ID received together with the command ID is registered at the context information DB 25 and the user DB 26 (Step S34). When the determination has “Yes”, determination is subsequently made based on the remote controller ID and the last mail reception time and date received together with the command ID whether context information updating time on the remote controller 1 side and that on the recorder 2a side coincide with each other (Step S35). More specifically, in this determination on coincidence of updating time, determination is made whether context information latest updating time and date in the column relevant to the received remote controller ID in the user DB 26 coincides with reception time and date of the lastly received mail. In practice, there is more or less a time difference caused by mail transmission and reception between reception time and date of a last mail and context information latest updating time and date in the user DB 26 and they never completely coincide with each other. Therefore, it is a common practice to determine, as long as a difference between the two times and dates is within a range of a predetermined time (time required for mail transmission and reception), that they coincide with each other.

When the determination at either Step S34 or S35 has “No”, cause the display unit 22 to display a message urging a press of the B button (Step S36) and thereafter return to Step S30. When the determination at Step S35 has “Yes”, conduct processing according to the received command ID (Step S37). Thereafter, determination is made whether the processing is finished (Step S38). When the determination has “No”, return to Step S30 and when the same has “Yes”, update context information in a relevant column of the second table of the context information DB 25 (Step S39) and thereafter return to Step S30.

The above-described processing at Step S37 includes power on/off processing by a command ID of the power button 31 shown in FIG. 3 which is described above and processing for contents reproduction (contents list display, contents selection, reproduction, stop, forwarding, rewinding, etc.) by a command ID of the control button 33. Ordinarily, first conduct processing of Steps S30 to S37 (power-on processing) in response to a press of the power button 31. In this power-on processing, determination at Step S38 will have “No”. Subsequently, conduct processing of Steps S30 to S37 (reproduction processing) in response to a press of the cross key 32 or the control button 33. The processing according to the press of the cross key 32 or the control button 33 includes each processing of contents serial display, contents selection, reproduction, stop, etc. and in any processing, determination at Step S38 will have “No”. Lastly, conduct processing of Steps S30 to S37 (power-off processing) in response to a press of the power button 31. In this power-off processing, determination at Step S38 will have “Yes” to conduct updating processing at Step S39.

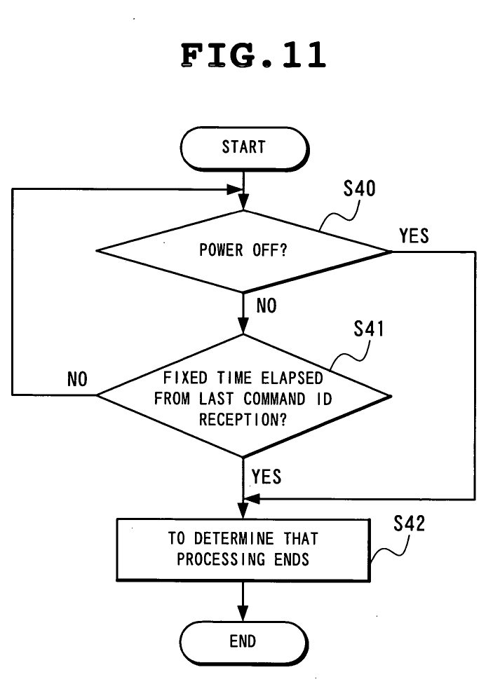

Determination on processing end at Step S38 is made, for example, by such a procedure as shown in FIG. 11. First, determination is made whether a command ID corresponding to power-off (press of the power button 31) is received or not (Step S40). When the determination has “No”, determination is subsequently made whether a fixed time has elapsed from the reception of the last command ID (Step S40). Here, a fixed time is a time exceeding a contents viewing and listening time. When any of the determinations at Steps S40 and S41 has “Yes”, determination is made that processing ends (Step S42). When the determination at Step S41 has “No”, return to Step S40. In this operation, power off operation at the remote controller 1 leads to determination on processing end and in addition, when moving to a different place with the stop button being pressed, for example, determination will be made on processing end after a lapse of the fixed time.

Next, description will be made of specific operation procedure and operation when continuity of contents reproduction is maintained between the recorders 2a and 2b by using the remote controller 1. Here, the description will be made with respect to a case, as an example, where with contents A accumulated in both of the recorders 2a and 2b, after viewing and listing to the contents A halfway by the recorder 2a, its continuation will be viewed and listened to by the recorder 2b.

A user first presses the power button 31 shown in FIG. 3 in order to turn off the power of the recorder 2a. When the power button 31 is pressed, the remote controller 1 transmits, to the recorder 2a, three information, a command ID of the power button 31, a remote controller ID and reception time and date of a mail lastly received from the recorder. Assume here that by the preceding operation by the remote controller 1, contents B were viewed and listened to by the recorder 2a and at the time of finishing the viewing and listening, the remote controller 1 received a mail from the recorder 2a.

Upon receiving the command ID of the power button 31 from the remote controller 1, the recorder 2a conducts processing of Steps S30 to S38 shown in FIG. 10. Every determination at Steps S30, S31, S34 and S35 has “Yes”, so that power-on processing in response to a press of the power button 31 is conducted at Step 37. Thus, the power of the recorder 2a is turned on.

When the power of the recorder 2a is turned on, the user subsequently presses the list button among the control buttons 33 in order to display a list of the contents accumulated in the recorder 2a. When the list button is pressed, the remote controller 1 transmits, to the recorder 2a, the above-described remote controller ID and reception time and date of a mail lastly received from the recorder together with a command ID of the list button. Upon receiving the command ID of the list button from the remote controller 1, the recorder 2a conducts processing of Steps S30 to S38 shown in FIG. 10. Every determination at Steps S30, S31, S34 and S35 has “Yes”, so that contents list display processing in response to the press of the list button is conducted at Step S37. Thus, the list of the contents accumulated in the recorder 2a is displayed on a screen of a TV as an external device.

When the list of contents is displayed, the user subsequently presses the cross key 32 in order to select the contents A from the displayed contents list. When the cross key 32 is pressed, the remote controller 1 transmits, to the recorder 2a, the above-described remote controller ID and reception time and date of a mail lastly received from the recorder together with a command ID of the cross key 32. Upon receiving the command ID of the cross key 32 from the remote controller 1, the recorder 2a conducts processing of Steps S30 to S38 shown in FIG. 10. Every determination at Steps S30, S31, S34 and S35 has “Yes”, so that contents selection processing in response to the press of the cross key 32 is conducted at Step S37. Thus, the contents A are selected from the list of the contents displayed on the TV screen.

When the contents A are selected, the user subsequently presses the reproduction button among the control buttons 33 in order to reproduce the contents A. When the reproduction button is pressed, the remote controller 1 transmits, to the recorder 2a, the above-described remote controller ID and reception time and date of a mail lastly received from the recorder together with a command ID of the reproduction button. Upon receiving the command ID of the reproduction button from the remote controller 1, the recorder 2a conducts processing of Steps S30 to S38 shown in FIG. 10. Every determination at Steps S30, S31, S34 and S35 has “Yes”, so that contents reproduction processing in response to the press of the reproduction button is conducted at Step S37. In this contents reproduction processing, with reference to the first table stored in the context information DB shown in FIG. 8, obtain a context information table pointer based on the remote controller ID received from the remote controller 1 and obtain context information of the contents A from the second table designated by the obtained context information table pointer. Then, based on the obtained context information, reproduce the contents A. Since at this stage, no context information related to the contents A is stored in the second table, the contents A will be reproduced from the beginning. Thus, the contents A are reproduced.

For stopping reproduction of the contents A, the user presses the stop button among the control buttons 33. When the stop button is pressed, the remote controller 1 transmits, to the recorder 2a, the above-described remote controller ID and reception time and date of a mail lastly received from the recorder together with a command ID of the stop button. Upon receiving the command ID of the stop button from the remote controller 1, the recorder 2a conducts processing of Steps S30 to S38 shown in FIG. 10. Every determination at Steps S30, S31, S34 and S35 has “Yes”, so that stop processing in response to the press of the stop button is conducted at Step S37. Thus, the reproduction of the contents A is stopped.

For ending viewing and listening of the contents A at the recorder 2a (which represents interruption halfway here), the user presses the power button 31 in order to turn off the power of the recorder 2a. When the power button 31 is pressed, the remote controller 1 transmits, to the recorder 2a, the above-described remote controller ID and reception time and date of a mail lastly received from the recorder together with the command ID of the power button 31. Upon receiving the command ID of the power button 31 from the remote controller 1, the recorder 2a conducts processing of Steps S30 to S38 shown in FIG. 10. Every determination at Steps S30, S31, S34 and S35 has “Yes”, so that power-off processing in response to the press of the power button 31 is conducted at Step S37. This power-off processing makes the determination at Step S38 have “Yes”. Then, at Step S39, context information in the column of the contents A in the second table stored in the context information DB 25 is updated, while a mail containing the updated contents is transmitted to the remote controller 1. At the same time of this mail transmission, context information latest updating time and date in the column of the relevant remote controller ID in the user DB 26 is updated.

When the mail from the recorder 2a is received by the wide area communication unit 11, processing of Steps S20 to S23 in FIG. 6 is conducted at the remote controller 1. Since at this stage, the contents ID related to the contents A is yet to be registered in the context information DB 15, registration processing of Step S22 will be conducted.

After interrupting the viewing and listening, the user moves with the remote controller 1 to a place where the recorder 2b is disposed and continues viewing and listening of the contents A there. At the time of this viewing and listening, the user first presses the power button 31 shown in FIG. 3 in order to turn on the power of the recorder 2b. It is assumed here that operation of the recorder 2b by the remote controller 1 has never been conducted before.

When the power button 31 is pressed, the remote controller 1 transmits, to the recorder 2b, the command ID of the power button 31, the remote controller ID and reception time and date of a mail lastly received from the recorder. The time and date of reception transmitted at this time is time and date of reception of a mail from the recorder 2a. When the command ID of the power button 31 is received from the remote controller 1, processing of Steps S30 to S36 shown in FIG. 10 is conducted at the recorder 2b. Either of the determinations at Steps S30 and S31 has “Yes” and the determination at Step S34 has “No”, so that a message urging a press of the B button is displayed on the display unit 22 at Step S36.

When the message urging a press of the B button is displayed, the user presses the updating button 30 of the remote controller 1. When the updating button 30 is pressed, the remote controller 1 transmits a command ID of the updating button 30, a mail address, the remote controller ID and context information of each contents (see FIG. 4) to the recorder 2b. When the command ID of the updating button 30 is received from the remote controller 1, the processing of Steps S30 to S33 shown in FIG. 10 is conducted at the recorder 2b. The determination at Step S30 has “Yes”, the determination at Step S31 has “No” and the determination at Step S32 has “Yes”, so that at Step S33, information registration to the context information DB 25 and the user DB 26 is conducted. Since at this stage, the remote controller ID received from the remote controller 1 is yet to be registered at the context information DB 25 and the user DB 26, register the remote controller ID received from the remote controller 1 at the first table of the context information DB 25, while newly generating a second table to store context information of each contents received from the remote controller 1 there and storing a table pointer to the second table in the column in which a previous remote controller ID of the first table is registered. Pressing the updating button 30 may be made before pressing the power button 31. In addition, it may be displayed on the display unit 22 that information registration is completed.

When the information registration to the context information DB 25 and the user DB 26 is completed, the user subsequently presses the power button 31 in order to turn on the power of the recorder 2b. When the power button 31 is pressed, the remote controller 1 transmits, to the recorder 2b, the above-described remote controller ID and reception time and date of a mail lastly received from the recorder together with the command ID of the power button 31. Upon receiving the command ID of the power button 31 from the remote controller 1, the recorder 2b conducts processing of Steps S30 to S38 shown in FIG. 10. Every determination at Steps S30, S31, S34 and S35 has “Yes”, so that power-on processing in response to the press of the power button 31 is conducted at Step S37. Thus, the power of the recorder 2a is turned on.

Processing hereafter (contents list display processing, contents selection processing, reproduction processing, stop processing and reproduction finishing processing) is the same as the above-described processing at the recorder 2a. In the contents reproduction processing, however, with reference to the first table stored in the context information DB 25 shown in FIG. 8, obtain a context information table pointer from the remote controller ID received from the remote controller 1 and obtain context information of the contents A from the second table designated by the obtained context information table pointer. Then, reproduce the continuation of the contents A based on the obtained context information.

Although in the foregoing description, operation has been described premised on that the contents A are accumulated in the recorders 2a and 2b, there is possibly a case where the contents A are not accumulated in the recorder 2b. In this case, in the processing of Step S37 in FIG. 10 conducted at the recorder 2b, when the list of contents is displayed on the TV screen, the contents A fail to exist in the displayed contents, so that the user finds from the display that the contents A are not accumulated in the recorder 2b and is allowed to cancel processing related to the reproduction of the contents A.

In addition, although it is designed to cause the display unit 22 to display a message urging a press of the B button, the display unit 22 may be alternatively formed of an LED (Light Emitting Diode) or the like to light to urge a press of the B button.

As described in the foregoing, because the contents reproduction system according to the present embodiment enables continuity of contents reproduction to be maintained between the two recorders 2a and 2b disposed at different places or houses, in a case of viewing and listening to the continuation of the contents A viewed and listened to halfway by the recorder 2a by means of the recorder 2b, the user is allowed to reproduce the contents by the recorder 2b immediately from a position at which the reproduction by the recorder 2a ends.

In addition, in a case where a plurality of remote controllers can be used for one recorder, by managing contents to be reproduced with respect to each remote controller, continuity of contents reproduction can be maintained between each remote controller and the recorder. This enables, in one house, for example, each user to manage context information of each individual by using a personal remote controller (including a portable phone) and enables even a case where a user is newly added to be coped with ease.

Since a mail address is personal information, it is desirable that transmission to a recorder should be reduced as much as possible. The contents reproduction system according to the present embodiment is designed to conduct processing for contents reproduction by the A button after registration/update of the context information DB 25 and the user DB 26 by the B button on the recorder side and in this case, one time of transmission of a mail address to the recorder is basically enough. Although by enciphering information transmitted by infrared communication, security can be ensured to some extent, using the two buttons, the A button and the B button, enables a system with higher security to be provided. When sufficient security can be ensured only by encryption, it is possible, without the provision of the B button, to simultaneously conduct processing corresponding to the processing by the B button at the time of pressing the A button.

Although in the above described contents reproduction system according to the present embodiment, contents are accumulated in each of the recorders 2a and 2b, the system may be designed to have a contents accumulation server on the internet 4 to accumulate contents common to the recorders 2a and 2b. This is equivalent, for example, to application to the system recited in the above-described Literature 2. In this case, the recorders 2a and 2b will display a list of contents stored in the contents accumulation server and obtain contents selected from the list from the contents accumulation server and reproduce the same. Also in this reproduction, continuity of contents reproduction between the recorders 2a and 2b is maintained.

It is also possible to have a structure in which the context information DB 25 is temporarily held in the recorders 2a and 2b. In processing conducted on the recorder side in this case, conducted in place of the processing at Step S33 in FIG. 10 is obtaining latest context information of each contents from the remote controller 1 upon pressing the button B and holding the obtained latest context information as the context information DB 25. The held context information DB 25 is erased after updating processing and mail transmission processing (processing at Step S39 in FIG. 10) is conducted. The processing at Step S35 in FIG. 10 will be unnecessary.

Although in the contents reproduction system according to the present embodiment, for the transmission of information from the recorder to the remote controller, mail transmission through the internet is used, other information transmission means may be used in place of this information transmission means. For example, it is possible to use an information transmission means employing a recording medium whose representative is an SD card. In this case, with the recorder and the remote controller each designed to adapted, for example, to an SD card, updated contents of context information and updating time are recorded on the SD card on the recorder side, and on the remote controller side, a context information DB in the remote controller is updated based on the updated contents of the context information which is recorded on the SD card. On the remote controller side, an updating time recorded on the SD card is used in place of mail reception time and date.

As another information transmission means, possible is a means provided with a radio communication function whose representative is “Bluetooth” provided in each of a remote controller and a recorder to transmit updated contents of context information and updating time from the recorder directly to the remote controller. Also in this case, received updating time is used in place of mail reception time and date.

As a further information transmission means, possible is a means which conducts transmission of information from a recorder to a remote controller by infrared communication. In this case, each of the recorder and the remote controller will be provided with two communication means, a local communication unit for reception and a local communication unit for transmission.

Possible as a still further information transmission means is a method of providing a recorder side with a function of displaying a bar code obtained by encoding information related to updated contents of context information on a TV screen when processing ends (Step S38 in FIG. 10) and providing a remote controller side with a camera function of imaging the displayed bar code and a processing function of obtaining updated contents of the original context information from an image of the imaged bar code, thereby transmitting the updated contents of the context information from the recorder to the remote controller. In this case, imaging time and date is used in place of mail reception time and date.

In addition, although in the contents reproduction system according to the present embodiment, the recorder is designed to display a list of accumulated contents on the TV screen by GUI (Graphical User Interface), the remote controller 1 side may be designed to have the display unit 12 display a contents list based on context information stored in the context information DB. In this case, the user selects a desired content from the contents list displayed in the display unit 12 of the remote controller 1 by using the cross key 32. According to this selection operation, the remote controller 1 transmits the selected contents ID and its context information to the recorder. The recorder reproduces contents based on the contents ID and the context information received from the remote controller 1. At this contents reproduction, when no relevant content exists in the accumulated contents, the recorder causes a message to that effect to be displayed on the TV screen.

(Second Embodiment)

While in the above-described embodiment, the remote controller and the recorder each have the context information DB, or the remote controller has the context information DB and the recorder temporarily stores the context information DB, the context information DB may be stored in an external storage device. Description will be here made of a contents reproduction system having such a storage device.

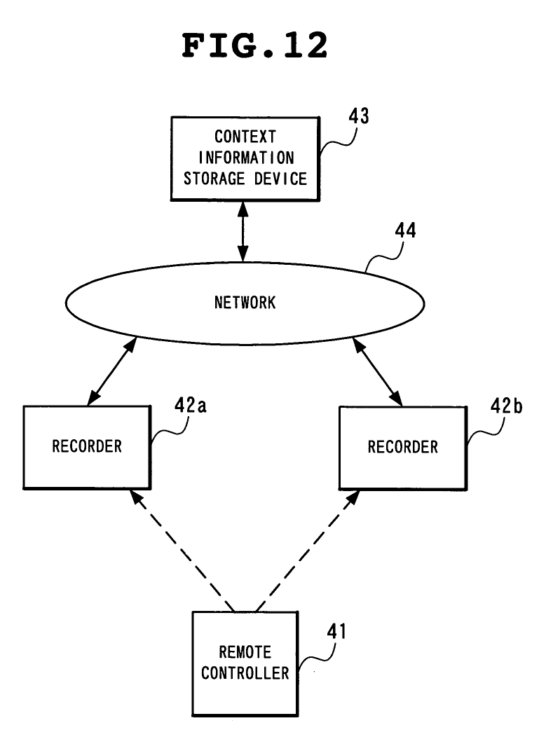

FIG. 12 shows a schematic diagram for use in explaining a contents reproduction system according to a second embodiment of the present invention. The contents reproduction system includes a remote controller 41, recorders 42a and 42b remotely operable by the remote controller 41 and a context information storage device 43 for storing a context information DB shared by these recorders 42a and 42b. The context information storage device 43 is connected to the recorders 42a and 42b through a network 44. The network 44 is a dedicated line or an internet. Stored as the shared context information DB stored in the context information storage device 43 is the context information DB shown in FIG. 4 stored for each remote controller ID. The remote controller 41 has basically the same structure as that shown in FIG. 2 excepting that the remote controller 41 has neither a context information DB nor a wide area communication unit. The recorders 42a and 42b have basically the same structure as that shown in FIG. 7 excepting that the recorders 42a and 42b have neither a context information DB nor a user DB.

In the following, description will be made of specific operation procedure and operation in a case of maintaining continuity of contents reproduction between the recorders 42a and 42b by using the remote controller 41. Here, the description will be made with respect a case, as an example, where with the contents A accumulated in both of the recorders 42a and 42b, after viewing and listening to the contents A by the recorder 42a, the continuation will be viewed and listened to by the recorder 42b.

In order to turn on the power of the recorder 42a, the user first presses the power button on the remote controller 41. When the power button is pressed, the remote controller 41 transmits two information, a command ID of the power button and a remote controller ID, to the recorder 42a. The recorder 42a executes power-on processing according the command ID of the power button received from the remote controller 41, as well as obtaining, from the context information storage device 43, context information relevant to the remote controller ID received from the remote controller 41 and temporarily holding the same. At this stage, the obtained context information includes no context information related to the contents A.

When the power of the recorder 42a is turned on, the user subsequently presses the list button on the remote controller 41 in order to display a list of contents accumulated in the recorder 42a. When the list button is pressed, the remote controller 41 transmits a command ID of the list button to the recorder 42a. The recorder 42a executes contents list display processing according to the command ID of the list button received from the remote controller 41. Thus, the list of the contents accumulated in the recorder 42a is displayed on a screen of a TV as an external device.

When the contents list is displayed, the user subsequently presses the cross key on the remote controller 41 in order to select the contents A from the displayed contents list. When the cross key is pressed, the remote controller 41 transmits a command ID of the cross key to the recorder 42a. The recorder 42a executes contents selection processing according to the command ID of the cross key received from the remote controller 41. Thus, the contents A are selected from the contents list displayed on the TV screen.

When the contents A are selected, the user subsequently presses the reproduction button on the remote controller 41 in order to reproduce the contents A. When the reproduction button is pressed, the remote controller 41 transmits a command ID of the reproduction button to the recorder 42a. The recorder 42a executes contents reproduction processing according to the command ID of the reproduction button received from the remote controller 41. Since in this contents reproduction processing, context information obtained from the context information storage device 43 includes no context information related to the contents A, the recorder 42a conducts ordinary reproduction (reproduction starting at the beginning of the contents).

For stopping reproduction of the contents A, the user presses the stop button on the remote controller 41. When the stop button is pressed, the remote controller 41 transmits a command ID of the stop button to the recorder 42a. The recorder 42a executes stop processing according to the command ID of the stop button received from the remote controller 41.

For finishing viewing and listening of the contents A by the recorder 42a (meaning that halfway interruption here), the user again presses the power button on the remote controller 41 in order to turn off the power of the recorder 42a. When the power button is pressed, the remote controller 41 transmits the command ID of the power button to the recorder 42a. The recorder 42a executes power-off processing according to the command ID of the power button received from the remote controller 41, as well as storing context information of the contents A in the context information storage device 43 so as to be correlated with the remote controller ID of the remote controller 41.

After interrupting the viewing and listening, the user moves with the remote controller 41 to a place where the recorder 42b is disposed and views and listens to the continuation of the contents A there. At the time of this viewing and listening, the user first presses the power button on the remote controller 41 in order to turn on the power of the recorder 42b. When the power button is pressed, the remote controller 41 transmits the command ID of the power button and the remote controller ID to the recorder 42b. The recorder 42b executes power-on processing according to the command ID of the power button received from the remote controller 41, as well as obtaining, from the context information storage device 43, context information relevant to the remote controller ID received from the remote controller 41 and temporarily holding the same. At this stage, the obtained context information contains context information related to the contents A.

When the power of the recorder 42b is turned on, the user subsequently presses the list button on the remote controller 41 in order to display a list of contents accumulated in the recorder 42b. When the list button is pressed, the remote controller 41 transmits the command ID of the list button to the recorder 42b. The recorder 42b executes contents list display processing according to the command ID of the list button received from the remote controller 41. Thus, the list of the contents accumulated in the recorder 42b is displayed on the screen of the TV as an external device.

When the contents list is displayed, the user subsequently presses the cross key on the remote controller 41 in order to select the contents A from the display contents list. When the cross key is pressed, the remote controller 41 transmits the command ID of the cross key to the recorder 42b. The recorder 42b executes contents selection processing according to the command ID of the cross key received from the remote controller 41. Thus, the contents A are selected from the contents list displayed on the TV screen.

When the contents A are selected, the user subsequently presses the reproduction button on the remote controller 41 in order to reproduce the continuation of the contents A. When the reproduction button is pressed, the remote controller 41 transmits the command ID of the reproduction button to the recorder 42b. The recorder 42b executes contents reproduction processing according to the command ID of the reproduction button received from the remote controller 41. Since in this contents reproduction processing, context information obtained from the context information storage device 43 includes context information related to the contents A, the recorder 42b conducts reproduction processing according to the context information related to the contents A. Thus, reproduction of the contents A will be made starting at a part where the preceding reproduction was stopped.

For finishing viewing and listening of the contents A by the recorder 42b, the user again presses the power button on the remote controller 41 in order to turn off the power of the recorder 42b. When the power button is pressed, the remote controller 41 transmits the command ID of the power button to the recorder 42b. The recorder 42b executes power-off processing according to the command ID of the power button received from the remote controller 41, as well as rewriting context information of the relevant contents A in the context information storage device 43. Thus, latest context information related to the contents reproduced by using the remote controller 41 is held in the context information storage device 43 to maintain continuity of contents reproduction between the recorders 42a and 42b.

In the case of the system according to the present embodiment, because the context information storage device 43 is arranged on the network, it is desirable that some means or other should be provided in order to prevent false access to the context information storage device 43.

(Third Embodiment)

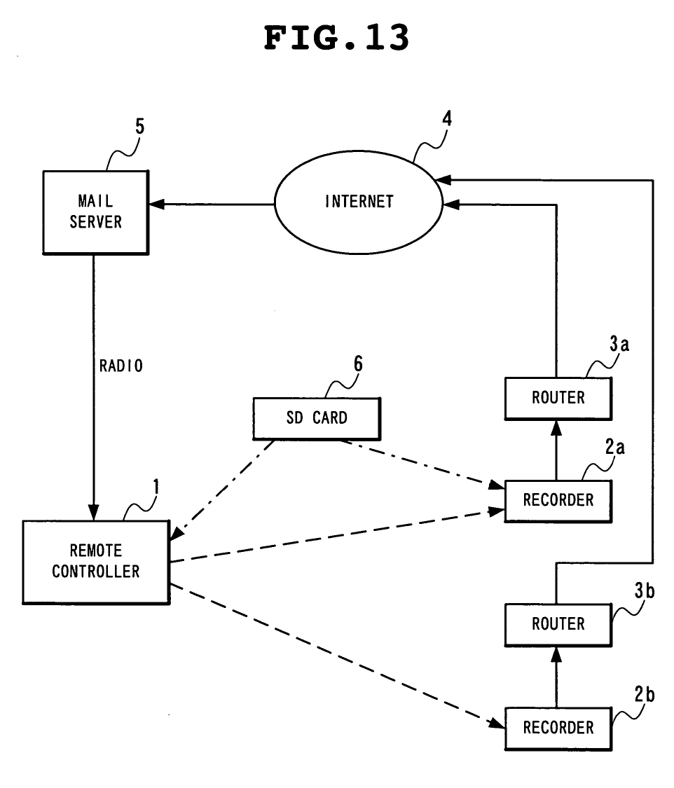

FIG. 13 shows a schematic diagram for use in explaining a contents reproduction system according to a third embodiment of the present invention. The contents reproduction system is equivalent to a system obtained by providing each of the remote controller 1 and the recorder 2a with a slot for inserting an SD card 6 or a socket for connecting the SD card 6 in the system shown in FIG. 1. The recorder 2a has a function of converting accumulated MPEG2 (Moving Picture Experts Group 2) system contents into MPEG4 system data and storing the converted data in the SD card 6. The remote controller 1 has a function of reproducing the MPEG4 system contents stored in the SD card 6 and a function of updating the context information DB shown in FIG. 4 at the time of finishing the contents reproduction.

In the following, description will be made of specific operation procedure and operation in a case of maintaining continuity of contents reproduction between the remote controller 1 and the recorders 2a and 2b. Here, the description will be made with respect a case, as an example, where after viewing and listening to the contents A halfway by the recorder 2a, its continuation will be viewed and listened to by the remote controller 1 and its further continuation will be viewed and listened to by the recorder 2b.

The user first views and listens to the contents A by the recorder 2a by using the remote controller 1. Viewing and listening to the contents A by the recorder 2a is conducted by the same procedure as the above-described procedure of the first embodiment (procedure shown in FIG. 10).

After interrupting the viewing and listening, the user inserts the SD card 6 into the recorder 2a to record the contents A on the SD card 6. Then, insert the SD card 6 with the contents A recorded into the remote controller 1 to view and listen to the contents A on the remote controller 1. At the time of viewing and listening to the contents A, on the remote controller 1, the contents A are reproduced according to context information related to the contents A in the context information DB 25 shown in FIG. 4. Since at this stage, the context information related to the contents A in the context information DB 25 is updated at the time of finishing the above-described viewing and listening by the recorder 2a, the user is allowed to reproduce the continuation of the contents A on the remote controller 1.

When the user conducts operation for finishing the viewing and listening of the contents A (more specifically, power-off operation) on the remote controller 1, the remote controller 1 updates the context information related to the contents A in the context information DB 25 shown in FIG. 4 to latest information, as well as changing mail reception time and date (time and date of receiving a mail from the recorder 2a here) to its updating time and date.

When viewing and listening to the continuation by the recorder 2b after the viewing and listening by the remote controller 1, the user moves with the remote controller 1 to a place where the recorder 2b is disposed to view and listen to the continuation of the contents A there. Viewing and listening of the contents A at the recorder 2b is conduced basically by the same procedure as the above-described procedure in the first embodiment (procedure shown in FIG. 10).

As described in the foregoing, because the contents reproduction system according to the present embodiment enables continuity of contents reproduction to be maintained between the two recorders 2a and 2b disposed at different places or houses and the remote controller 1, respectively, the user is allowed to view and listen to the continuation of the contents A halfway viewed and listened to by the recorder 2a by means of the remote controller 1 while he/she moves, and is allowed to view and listen to the further continuation by the recorder 2b, that is, to reproduce the contents A starting at a part where the user interrupted, without conducting forwarding operation and the like.

As described above, the present invention has the effect of enabling reproduction of contents by a device different from a device used last time to be started immediately at a place where the last reproduction ends.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A contents reproduction system, comprising:
a reproduction device which reproduces contents,
a remote control device which remotely operates said reproduction device, and
a context information storage device which stores context information related to reproduction of said contents, wherein
said reproduction device, when reproducing said contents by remote operation, rewrites the context information in said context information storage device based on a state of the contents in question as of after reproduction.

2. The contents reproduction system as set forth in claim 1, wherein
said reproduction device includes
first communication unit, and
a first control unit which transmits updated contents based on a state of said contents as of after reproduction from said first communication unit to said remote control device, and
said remote control device includes
second communication unit which receives the updated contents transmitted from said reproduction device, and
a second control unit which updates the context information in said context information storage device based on the updated contents received by said second communication unit.

3. The contents reproduction system as set forth in claim 1, wherein
said reproduction device includes
first communication unit, and
a first control unit which transmits updated contents based on a state of said contents as of after reproduction from said first communication unit to said remote control device, and
said remote control device includes
second communication unit which receives the updated contents transmitted from said reproduction device, and
a second control unit which updates the context information in said context information storage device based on the updated contents received by said second communication unit,
said first communication unit transmits a mail containing said updated contents and said second communication unit receives said mail.

4. The contents reproduction system as set forth in claim 1, wherein
said reproduction device includes:
first communication unit, and
a first control unit which transmits updated contents based on a state of said contents as of after reproduction from said first communication unit to said remote control device, and
said remote control device includes:
second communication unit which receives the updated contents transmitted from said reproduction device, and
a second control unit which updates the context information in said context information storage device based on the updated contents received by said second communication unit,
said first and second communication unit are a radio communication unit.

5. The contents reproduction system as set forth in claim 1, further comprising
a recording medium attachable to each of said reproduction device and said remote control device, wherein
said reproduction device records updated contents based on a state of said contents as of after reproduction on said recording medium, and
when said recording medium in which said updated contents are recorded is attached, said remote control device reads said updated contents from the attached recording medium to update the context information in said context information storage device based on the read updated contents.

6. The contents reproduction system as set forth in claim 1, wherein
said context information storage device and said reproduction device are connected to be communicable with each other through a network and said reproduction device directly updates the context information in said context information storage device based on a state of said contents as of after reproduction.

7. The contents reproduction system as set forth in claim 1, further comprising
other remote control device which remotely operates said reproduction device, wherein
with said context information being stored for each said remote control device, said context information storage device, when said reproduction device reproduces said contents by remote operation of any of the remote control devices, rewrites context information of the relevant remote control device in said context information storage device based on a state of the contents in question as of after reproduction.

8. The contents reproduction system as set forth in claim 1, wherein
said context information storage device includes a first data base where a contents ID which specifies said contents and said context information are stored to be correlated with each other, the first data base being provided in said remote control device.

9. The contents reproduction system as set forth in claim 1, wherein
said context information storage device includes a first data base where a contents ID which specifies said contents and said context information are stored to be correlated with each other, the first data base being provided in said remote control device,
said context information storage device further includes:
a second data base where a device ID which specifies said remote control device, said contents ID and context information are stored to be correlated with each other, and
a third data base where a mail address set in advance to said remote control device and context information latest updating time and date equivalent to time and date when said context information is rewritten last are stored to be correlated with said device ID,
said second and third data bases being provided in said reproduction device,
said reproduction device rewrites the context information in said second data base based on a state of said contents as of after reproduction, as well as updating the context information latest updating time and date in said third data base to transmit the rewritten contents of the context information in question to the mail address in said third data base, and
said remote control device updates the context information in said first data base based on contents of a mail received from said reproduction device.

10. The contents reproduction system as set forth in claim 1, wherein
said context information storage device includes a first data base where a contents ID which specifies said contents and said context information are stored to be correlated with each other, the first data base being provided in said remote control device,
said context information storage device further includes:
a second data base where a device ID which specifies said remote control device, said contents ID and context information are stored to be correlated with each other, and
a third data base where a mail address set in advance to said remote control device and context information latest updating time and date equivalent to time and date when said context information is rewritten last are stored to be correlated with said device ID,
said second and third data bases being provided in said reproduction device,
said reproduction device rewrites the context information in said second data base based on a state of said contents as of after reproduction, as well as updating the context information latest updating time and date in said third data base to transmit the rewritten contents of the context information in question to the mail address in said third data base,
said remote control device updates the context information in said first data base based on contents of a mail received from said reproduction device,
said reproduction device further includes a display unit,
said remote control device transmits time and date when the context information in said first data base is updated last to said reproduction device, and
said reproduction device checks whether the time and date received from said remote control device coincides with the context information latest updating time and date in said third data base and when the times and dates fail to coincide with each other, causes said display unit to make a display urging update of the context information in said second data base.

11. The contents reproduction system as set forth in claim 1, wherein
said context information storage device includes a first data base where a contents ID which specifies said contents and said context information are stored to be correlated with each other, the first data base being provided in said remote control device,
said context information storage device further includes:
a second data base where a device ID which specifies said remote control device, said contents ID and context information are stored to be correlated with each other, and
a third data base where a mail address set in advance to said remote control device and context information latest updating time and date equivalent to time and date when said context information is rewritten last are stored to be correlated with said device ID,
said second and third data bases being provided in said reproduction device,
said reproduction device rewrites the context information in said second data base based on a state of said contents as of after reproduction, as well as updating the context information latest updating time and date in said third data base to transmit the rewritten contents of the context information in question to the mail address in said third data base,
said remote control device updates the context information in said first data base based on contents of a mail received from said reproduction device,
said reproduction device further includes a display unit,
said remote control device transmits time and date when the context information in said first data base is updated last to said reproduction device,
said reproduction device checks whether the time and date received form said remote control device coincides with the context information latest updating time and date in said third data base and when the times and dates fail to coincide with each other, causes said display unit to make a display urging update of the context information in said second data base,
said remote control device includes an updating button and when a user presses said updating button according to said display urging update, transmits the context information in said first data base to said reproduction device, and
said reproduction device updates the context information in said second data base based on the context information received from said remote control device.

12. The contents reproduction system as set forth in claim 1, wherein
said context information storage device includes a first data base where a contents ID which specifies said contents and said context information are stored to be correlated with each other, the first data base being provided in said remote control device,
said context information storage device further includes:
a second data base where a device ID which specifies said remote control device, said contents ID and context information are stored to be correlated with each other, and
a third data base where a mail address set in advance to said remote control device and context information latest updating time and date equivalent to time and date when said context information is rewritten last are stored to be correlated with said device ID,
said second and third data bases being provided in said reproduction device,
said reproduction device rewrites the context information in said second data base based on a state of said contents as of after reproduction, as well as updating the context information latest updating time and date in said third data base to transmit the rewritten contents of the context information in question to the mail address in said third data base,
said remote control device updates the context information in said first data base based on contents of a mail received from said reproduction device, and
said reproduction device is capable of reproducing at least one other contents than said contents,
said first and second data bases each storing said contents ID and said context information with respect to each said contents.

13. The contents reproduction system as set forth in claim 1, wherein
said context information storage device includes a first data base where a contents ID which specifies said contents and said context information are stored to be correlated with each other, the first data base being provided in said remote control device,
said context information storage device further includes:
a second data base where a device ID which specifies said remote control device, said contents ID and context information are stored to be correlated with each other, and
a third data base where a mail address set in advance to said remote control device and context information latest updating time and date equivalent to time and date when said context information is rewritten last are stored to be correlated with said device ID,
said second and third data bases being provided in said reproduction device,
said reproduction device rewrites the context information in said second data base based on a state of said contents as of after reproduction, as well as updating the context information latest updating time and date in said third data base to transmit the rewritten contents of the context information in question to the mail address in said third data base, and
said remote control device updates the context information in said first data base based on contents of a mail received from said reproduction device, and which further comprises other remote control device which remotely operates said reproduction device, wherein
said second data base stores said contents ID and said context information with respect to each said remote control device, and
said third data base stores said mail address and said context information latest updating time and date with respect to each said remote control device.

14. The contents reproduction system as set forth in claim 1, wherein
said context information storage device includes a first data base where a contents ID which specifies said contents and said context information are stored to be correlated with each other, the first data base being provided in said remote control device,
said context information storage device further includes:
a second data base where a device ID which specifies said remote control device, said contents ID and context information are stored to be correlated with each other, and
a third data base where a mail address set in advance to said remote control device and context information latest updating time and date equivalent to time and date when said context information is rewritten last are stored to be correlated with said device ID,
said second and third data bases being provided in said reproduction device,
said reproduction device rewrites the context information in said second data base based on a state of said contents as of after reproduction, as well as updating the context information latest updating time and date in said third data base to transmit the rewritten contents of the context information in question to the mail address in said third data base,
said remote control device updates the context information in said first data base based on contents of a mail received from said reproduction device, and
said reproduction device is capable of reproducing at least one other contents than said contents,
said first and second data bases each storing said contents ID and said context information with respect to each said contents, and which further comprises other remote control device which remotely operates said reproduction device, wherein
said second data base stores said contents ID and said context information with respect to each said remote control device, and
said third data base stores said mail address and said context information latest updating time and date with respect to each said remote control device.

15. The contents reproduction system as set forth in claim 1, further comprising
a recording medium attachable to each of said reproduction device and said remote control device, wherein
said reproduction device further includes recording unit which records said contents on said recording medium, and
said remote control device further includes reproduction unit which reproduces contents recorded in said recording medium and when the reproduction unit reproduces contents recorded in said recording medium, rewrites the context information in said context information storage device based on a state of the contents in question as of after reproduction.

16. The contents reproduction system as set forth in claim 1, further comprising
a recording medium attachable to each of said reproduction device and said remote control device, wherein
said reproduction device further includes recording unit which records said contents on said recording medium,
said remote control device further includes reproduction unit which reproduces contents recorded in said recording medium and when the reproduction unit reproduces contents recorded in said recording medium, rewrites the context information in said context information storage device based on a state of the contents in question as of after reproduction,
said context information storage device includes a data base where a contents ID which specifies said contents and said context information are stored to be correlated with each other,
said data base being provided in said remote control device, and wherein
said remote control device rewrites the context information in said data base based on a state of contents reproduced by said reproduction unit.

17. The contents reproduction system as set forth in claim 1, further comprising
a recording medium attachable to each of said reproduction device and said remote control device, wherein
said reproduction device further includes recording unit which records said contents on said recording medium,
said remote control device further includes reproduction unit which reproduces contents recorded in said recording medium and when the reproduction unit reproduces contents recorded in said recording medium, rewrites the context information in said context information storage device based on a state of the contents in question as of after reproduction,
said context information storage device includes a data base where a contents ID which specifies said contents and said context information are stored to be correlated with each other,
said data base being provided in said remote control device, and wherein
said remote control device here rewrites the context information in said data base based on a state of contents reproduced by said reproduction unit,
said reproduction device is capable of reproducing at least one other contents than said contents,
said data base storing said contents ID and said context information with respect to each said contents, and
said recording unit recording contents selected from among said reproducible contents on said recording medium, and
said remote control device rewrites context information of relevant contents in said data base based on a state of contents reproduced by said reproduction unit.

18. A contents reproduction method executed in a system having a reproduction device which reproduces contents, a remote control device which remotely operates said reproduction device, and a context information storage device which stores context information related to reproduction of said contents, comprising the step of
said reproduction device, after reproducing said contents by remote operation, rewriting the context information in said context information storage device based on a state of the contents in question as of after reproduction.

19. The contents reproduction method as set forth in claim 18, comprising:
a step of said reproduction device of transmitting updated contents based on a state of said contents as of after reproduction to said remote control device, and
a step of said remote control device of updating the context information in said context information storage device based on the updated contents received from said reproduction device.

20. The contents reproduction method as set forth in claim 18, wherein
transmission of said updated contents from said reproduction device to said remote control device is conducted by mail.

21. The contents reproduction method as set forth in claim 18, wherein
transmission of said updated contents from said reproduction device to said remote control device is conducted by radio communication.

22. The contents reproduction method as set forth in claim 18, comprising:
a step of said reproduction device of recording updated contents based on a state of said contents as of after reproduction on a recording medium attached, and
a step of said remote control device, when the recording medium in which said updated contents are recorded is attached, of reading said updated contents from the attached recording medium to update the context information in said context information storage device based on the read updated contents.

23. The contents reproduction method as set forth in claim 18, wherein
said context information storage device and said reproduction device are connected to be communicable with each other through a network and said reproduction device directly updates the context information in said context information storage device based on a state of said contents as of after reproduction.

24. The contents reproduction method as set forth in claim 18, further comprising:
a step of said context information storage device of storing said context information related to other remote control device which remotely operates said reproduction device than said remote control device, and
a step of said reproduction device, when reproducing said contents by remote operation of any of the remote control devices, of rewriting context information of the relevant remote control device in said context information storage device based on a state of the contents in question as of after reproduction.

25. The contents reproduction method as set forth in claim 18, further comprising:
with a first data base as said context information storage device provided in said remote control device, a step of the first data base of storing a contents ID which specifies said contents and said context information so as to be correlated with each other.

26. The contents reproduction method as set forth in claim 18, comprising:
with a first data base as said context information storage device provided in said remote control device, a step of the first data base of storing a contents ID which specifies said contents and said context information so as to be correlated with each other,
with second and third data bases as said context information storage device provided in said reproduction device, a step of said second data base of storing a device ID which specifies said remote control device, said contents ID and context information so as to be correlated with each other, and a step of said third data base of storing a mail address set in advance to said remote control device and context information latest updating time and date equivalent to time and date when said context information is rewritten last so as to be correlated with said device ID,
a step of said reproduction device of rewriting the context information in said second data base based on a state of said contents as of after reproduction, as well as updating the context information latest updating time and date in said third data base to transmit the rewritten contents of the context information in question to the mail address in said third data base, and
a step of said remote control device of updating the context information in said first data base based on contents of a mail received from said reproduction device.

27. The contents reproduction method as set forth in claim 18, comprising:
with a first data base as said context information storage device provided in said remote control device, a step of the first data base of storing a contents ID which specifies said contents and said context information so as to be correlated with each other,
with second and third data bases as said context information storage device provided in said reproduction device, a step of said second data base of storing a device ID which specifies said remote control device, said contents ID and context information so as to be correlated with each other, and a step of said third data base of storing a mail address set in advance to said remote control device and context information latest updating time and date equivalent to time and date when said context information is rewritten last so as to be correlated with said device ID,
a step of said reproduction device of rewriting the context information in said second data base based on a state of said contents as of after reproduction, as well as updating the context information latest updating time and date in said third data base to transmit the rewritten contents of the context information in question to the mail address in said third data base,
a step of said remote control device of updating the context information in said first data base based on contents of a mail received from said reproduction device,
a step of said remote control device of transmitting time and date when the context information in said first data base is updated last to said reproduction device, and
a step of said reproduction device of checking whether the time and date received from said remote control device coincides with the context information latest updating time and date in said third data base and when the times and dates fail to coincide with each other, making a display urging update of the context information in said second data base.

28. The contents reproduction method as set forth in claim 18, comprising:
with a first data base as said context information storage device provided in said remote control device, a step of the first data base of storing a contents ID which specifies said contents and said context information so as to be correlated with each other,
with second and third data bases as said context information storage device provided in said reproduction device, a step of said second data base of storing a device ID which specifies said remote control device, said contents ID and context information so as to be correlated with each other, and a step of said third data base of storing a mail address set in advance to said remote control device and context information latest updating time and date equivalent to time and date when said context information is rewritten last so as to be correlated with said device ID,
a step of said reproduction device of rewriting the context information in said second data base based on a state of said contents as of after reproduction, as well as updating the context information latest updating time and date in said third data base to transmit the rewritten contents of the context information in question to the mail address in said third data base,
a step of said remote control device of updating the context information in said first data base based on contents of a mail received from said reproduction device,
a step of said remote control device of transmitting time and date when the context information in said first data base is updated last to said reproduction device,
a step of said reproduction device of checking whether the time and date received from said remote control device coincides with the context information latest updating time and date in said third data base and when the times and dates fail to coincide with each other, making a display urging update of the context information in said second data base,
a step of said remote control device of, when a user conducts predetermined input operation according to said display urging update, transmitting the context information in said first data base to said reproduction device, and
a step of said reproduction device of updating the context information in said second data base based on the context information received from said remote control device.

29. The contents reproduction method as set forth in claim 18, comprising:
with a first data base as said context information storage device provided in said remote control device, a step of the first data base of storing a contents ID which specifies said contents and said context information so as to be correlated with each other,
with second and third data bases as said context information storage device provided in said reproduction device, a step of said second data base of storing a device ID which specifies said remote control device, said contents ID and context information so as to be correlated with each other, and a step of said third data base of storing a mail address set in advance to said remote control device and context information latest updating time and date equivalent to time and date when said context information is rewritten last so as to be correlated with said device ID,
a step of said reproduction device of rewriting the context information in said second data base based on a state of said contents as of after reproduction, as well as updating the context information latest updating time and date in said third data base to transmit the rewritten contents of the context information in question to the mail address in said third data base,
a step of said remote control device of updating the context information in said first data base based on contents of a mail received from said reproduction device, and
a step of each of said first and second data bases of storing said contents ID related to at least one other contents than said contents and said context information.

30. The contents reproduction method as set forth in claim 18, comprising:
with a first data base as said context information storage device provided in said remote control device, a step of the first data base of storing a contents ID which specifies said contents and said context information so as to be correlated with each other,
with second and third data bases as said context information storage device provided in said reproduction device, a step of said second data base of storing a device ID which specifies said remote control device, said contents ID and context information so as to be correlated with each other, and a step of said third data base of storing a mail address set in advance to said remote control device and context information latest updating time and date equivalent to time and date when said context information is rewritten last so as to be correlated with said device ID,
a step of said reproduction device of rewriting the context information in said second data base based on a state of said contents as of after reproduction, as well as updating the context information latest updating time and date in said third data base to transmit the rewritten contents of the context information in question to the mail address in said third data base,
a step of said remote control device of updating the context information in said first data base based on contents of a mail received from said reproduction device,
a step of said second data base of storing said contents ID related to other remote control device which remotely operates said reproduction device than said remote control device and said context information, and
a step of said third data base of storing said mail address and said context information latest update time and date with respect to each said remote control device.

31. The contents reproduction method as set forth in claim 18, comprising:
with a first data base as said context information storage device provided in said remote control device, a step of the first data base of storing a contents ID which specifies said contents and said context information so as to be correlated with each other,
with second and third data bases as said context information storage device provided in said reproduction device, a step of said second data base of storing a device ID which specifies said remote control device, said contents ID and context information so as to be correlated with each other, and a step of said third data base of storing a mail address set in advance to said remote control device and context information latest updating time and date equivalent to time and date when said context information is rewritten last so as to be correlated with said device ID,
a step of said reproduction device of rewriting the context information in said second data base based on a state of said contents as of after reproduction, as well as updating the context information latest updating time and date in said third data base to transmit the rewritten contents of the context information in question to the mail address in said third data base,
a step of said remote control device of updating the context information in said first data base based on contents of a mail received from said reproduction device,
a step of each of said first and second data bases of storing said contents ID related to at least one other contents than said contents and said context information,
a step of said second data base of storing said contents ID related to other remote control device which remotely operates said reproduction device than said remote control device and said context information, and
a step of said third data base of storing said mail address and said context information latest update time and date with respect to each said remote control device.

32. The contents reproduction method as set forth in claim 18, comprising:
a step of said reproduction device of recording said contents on a recording medium attached, and
a step of said remote control device, when said recording medium is attached, of reproducing the contents recorded in the recording medium to rewrite the context information in said context information storage device based on a state of the contents in question as of after reproduction.

33. The contents reproduction method as set forth in claim 18, comprising:
a step of said reproduction device of recording said contents on a recording medium attached,
a step of said remote control device, when said recording medium is attached, of reproducing the contents recorded in the recording medium to rewrite the context information in said context information storage device based on a state of the contents in question as of after reproduction,
with a data base as said context information storage device disposed in said remote control device, a step of the data base of storing a contents ID which specifies said contents and said context information so as to be correlated with each other, and
a step of said remote control device of rewriting the context information in said data base based on a state of the contents recorded on said recording medium as of after reproduction.

34. The contents reproduction method as set forth in claim 18, comprising:
a step of said reproduction device of recording said contents on a recording medium attached,
a step of said remote control device, when said recording medium is attached, of reproducing the contents recorded in the recording medium to rewrite the context information in said context information storage device based on a state of the contents in question as of after reproduction,
with a data base as said context information storage device disposed in said remote control device, a step of the data base of storing a contents ID which specifies said contents and said context information so as to be correlated with each other,
a step of said remote control device of rewriting the context information in said data base based on a state of the contents recorded on said recording medium as of after reproduction,
a step of said data base of storing said contents ID related to at least one other contents than said contents and said context information,
a step of said reproduction device of recording contents selected from among said contents on said recording medium, and
a step of said remote control device of rewriting context information of relevant contents in said data base based on a state of the contents recorded on said recording medium as of after reproduction.

35. A reproduction device which reproduces contents, which
is connected to a context information storage device which stores context information related to reproduction of said contents, and
when reproducing said contents by remote operation of a remote control device, rewrites the context information in said context information storage device based on a state of the contents in question as of after reproduction.

36. The reproduction device as set forth in claim 35, comprising:
first communication unit, and
a first control unit which causes transmission of updated contents based on a state of said contents as of after reproduction from said first communication unit to said remote control device, wherein
said remote control device includes:
second communication unit which receives the updated contents transmitted from said reproduction device, and
a second control unit which updates the context information in said context information storage device based on the updated contents received by said second communication unit.

37. The reproduction device as set forth in claim 35, comprising:
first communication unit, and
a first control unit which causes transmission of updated contents based on a state of said contents as of after reproduction from said first communication unit to said remote control device, wherein
said remote control device includes:
second communication unit which receives the updated contents transmitted from said reproduction device, and
a second control unit which updates the context information in said context information storage device based on the updated contents received by said second communication unit,
said first communication unit transmits a mail containing said updated contents and said second communication unit receives said mail.

38. The reproduction device as set forth in claim 35, comprising:
first communication unit, and
a first control unit which causes transmission of updated contents based on a state of said contents as of after reproduction from said first communication unit to said remote control device, wherein
said remote control device includes:
second communication unit which receives the updated contents transmitted from said reproduction device, and
a second control unit which updates the context information in said context information storage device based on the updated contents received by said second communication unit,
said first and second communication unit are a radio communication unit.
